(19) United States
(12) Patent Application Publication
(10) Pub. No.: US 2004/0020050 A1
(43) Pub. Date: Feb. 5, 2004

(54) Method for manufacturing a fluid coupling

(75) Inventor: Nigel D.L. Williamson, Sheffield (GB)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(73) Assignee: Pilot Industries, Inc., Dexter, MI

(21) Appl. No.: 10/210,150

(22) Filed: Aug. 1, 2002

(51) Int. Cl. B23P 13/04

(52) U.S. Cl. 29/890.148; 29/557

(57) ABSTRACT

A method for manufacturing a fluid coupling including the steps of forming an elongated bar stock having a profile with a longitudinally extending protuberance projecting radially outwardly from a longitudinal axis of the bar stock. A longitudinal section of the bar stock is then machined in the end of the bar and that section includes a portion of the protuberance. A first fluid passageway is machined longitudinally in the machined section while a second fluid passageway is machined in the protruding portion of the machined section. The axis of the first fluid passageway intersects the axis of the second fluid passageway at an angle.

### BACKGROUND OF THE INVENTION

I. Field of the Invention

The present invention relates generally to manufacturing methods and, more particularly, to a method for manufacturing a fluid coupling.

II. Description of Related Art

Fluid couplings, for example hydraulic fittings, are utilized extensively in many industries, such as the automotive industry. Furthermore, many such hydraulic couplings require a redirection of fluid flow through the coupling. Additionally, many of these fluid couplings, known as banjo couplings, require a relatively low profile for the coupling in view of size restraints in their ultimate application.

There were previously two widely accepted methods for manufacturing banjo couplings. In the first method, a section of round bar stock is pre-machined on a multi-spindle screw machine and removed and subsequently machined by conventional machining operations, such as milling, drilling and recessing, etc., to form the banjo coupling. One disadvantage of this previously known method, however, is that, due to the redirection of flow through the banjo coupling, a fluid passageway necessarily extends radially outwardly from a longitudinal passageway formed through the coupling. As such, in order to manufacture these previously known fluid couplings from bar stock, a relatively large amount of material is wasted, i.e. machined away, during the machining process.

A still further disadvantage of this first previously known method for manufacturing banjo couplings is that a relatively large number of sequential machining operations are necessary to completely form the banjo coupling. As such, the machining cost for the banjo coupling is relatively high.

In a second previously known method for manufacturing banjo couplings, the banjo coupling is formed in two or more parts. For example, one part would correspond to the longitudinal passageway formed in the banjo coupling while a second part would correspond to the radially extending passageway in the banjo coupling. After forming both parts, the parts are then brazed together.

The second method for manufacturing banjo couplings reduces the material wastage incurred when manufacturing the banjo coupling from cylindrical bar stock. However, such multi-part banjo couplings are subjected to potential failure in operation across the braze interface.

### SUMMARY OF THE PRESENT INVENTION

The present invention provides a method for manufacturing fluid couplings which overcomes the disadvantages of the previously known manufacturing methods.

In brief, the method of the present invention comprises the first step of forming an elongated bar stock having a profile. In the profile, the bar stock includes both a longitudinal axis and a longitudinally extending protuberance projecting radially outwardly from the longitudinal axis of the bar stock. This protuberance extends along the entire longitudinal length of the bar stock. Furthermore, the bar stock is preferably formed by drawing standard bar stock typically cylindrical in cross section through forming dies.

Thereafter, a longitudinal section of the bar stock is machined in the end of the bar. The machined section, furthermore, includes both a longitudinal axis, corresponding to the longitudinal axis of the bar stock, as well as a portion of the protuberance extending radially outwardly from the longitudinal axis of the machined section.

A first passageway is machined longitudinally in the machined section by any conventional fashion, such as drilling and recessing on a screw machine. Thereafter, a second passageway is formed in the outwardly protruding portion of the machined section in any conventional fashion, such as by cross-drilling on the screw machine or as a simple second operation. Furthermore, the axes of the first and second fluid passageways intersect each other at an angle to achieve the desired flow redirection.

A primary advantage of the present invention is that, by initially profiling the bar stock so that the profiled bar stock includes the radially outwardly extending protuberance extending longitudinally along the profile bar stock, material wastage from machining is minimized. Additionally, since the final fluid coupling is of a one piece construction, the possibility of failure of the fluid coupling across a braze interface known to the prior art is completely eliminated. Additionally, as intricate drilling and recessing operations can be performed in primary machining operations on the screw machine, considerable additional cost savings can be realized, both in time and capital expenditure.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a side view illustrating a profile bar stock utilized in the method of the present invention;

FIG. 2 is a sectional view taken substantially along line 2-2 in FIG. 1;

FIG. 3 is a side view of a removed section of the bar stock following machining on the outer periphery of the bar stock;

FIG. 4 is a longitudinal sectional view illustrating a completed fluid coupling manufactured in accordance with the method of the present invention;

FIG. 5 is an end view illustrating a second preferred embodiment of the invention;

FIG. 6 is an end view illustrating a third preferred embodiment of the invention;

FIG. 7 is an end view illustrating a fourth preferred embodiment of the invention;

FIG. 8 is a sectional view taken along line 8-8 in FIG. 7; and

FIG. 9 is a side view of the fourth preferred embodiment of the invention.

### DETAILED DESCRIPTION OF A PREFERRED EMBODIMENT OF THE PRESENT INVENTION

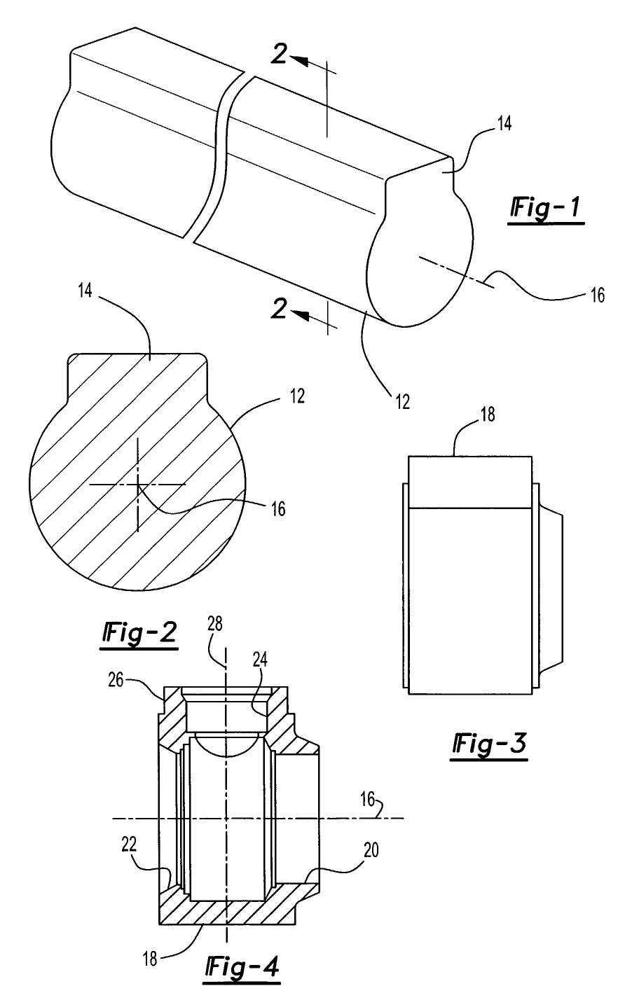

With reference first to FIGS. 1 and 2, in the preferred embodiment of the present invention, an elongated bar stock 12 having a profile is first formed such that the profile includes a longitudinally extending protuberance 14 projecting radially outwardly from a longitudinal axis 16 of the profile bar stock 12. Preferably, the profile bar stock 12 is formed from square or cylindrical bar stock of metal or other suitable material which is drawn through forming dies to form the longitudinally extending and radially outwardly projecting protuberance 14 along the profile bar stock 12 illustrated in FIG. 1. Although only one longitudinally extending protuberance 14 is illustrated in FIGS. 1 and 2, it will be understood that two or even more protuberances may be formed on this profile to accommodate multiple radial passageways.

After forming the profile bar stock 12, an end section 18 is machined in the bar stock in any conventional fashion, such as by screw machining. The outer periphery of the machined section 18 is formed on the machine to form its outer periphery as shown in FIG. 3.

With reference now to FIG. 4, in the same machining cycle in which the outer periphery of the formed end section 18 of the bar stock 12 is machined, at least one fluid passageway 20 is machined in any conventional fashion, such as by drilling, recessing, etc., such that the passageway 20 is parallel to the longitudinal axis 16 of the machined section 18 of the profile bar stock 12. Optionally, a second fluid passageway 22 is also machined in the machined section 18 such that the fluid passageway 22 is aligned with but opposed from the fluid passageway 20.

Thereafter, an additional fluid passageway 24 is machined in the outwardly protruding portion 26 of the machined section 18. This fluid passageway 24, furthermore, is formed along an axis 28 which intersects the longitudinal axis 16 at an angle. Although the axis 28 is illustrated in FIG. 4 as intersecting the longitudinal axis 16 at substantially a right angle, it will be understood that the axes 16 and 28 of the fluid passageways 20 and 24 may intersect at other angles without deviation from the spirit or scope of the invention. Likewise, it will also be understood that alternatively the second fluid passageway 24 may be machined prior to the machining of the first fluid passageway 20 without deviation from the spirit or scope of the invention.

Although the end section 18 is preferably removed by cutting from the bar stock 12 following the machining operations, alternatively the end section 18 is first removed from the bar stock 12 and then machined to form the fluid passageways.

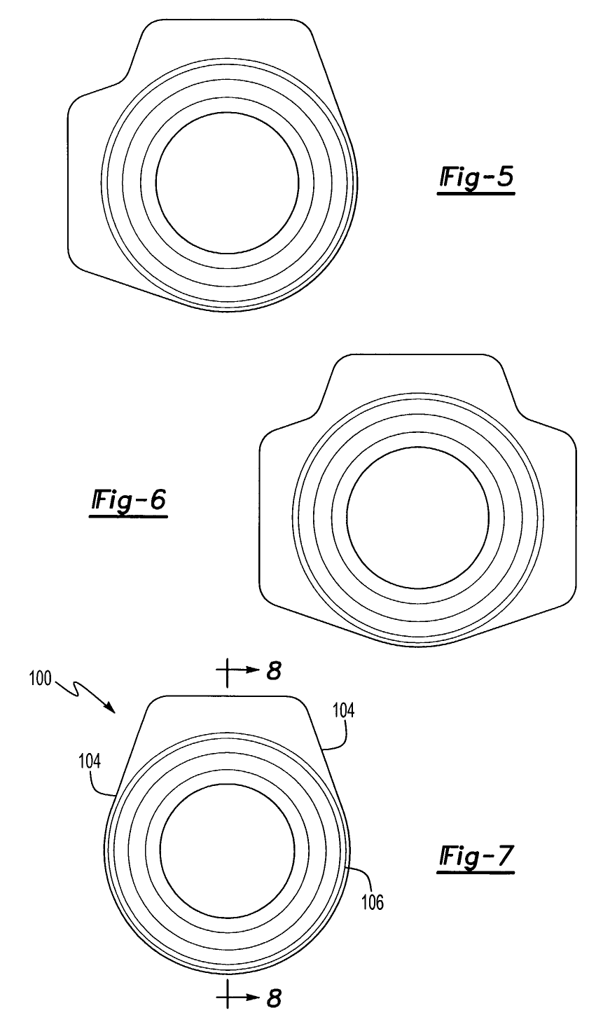

FIGS. 5 and 6 show two alternative fluid couplings according to the present invention. FIG. 5 is an end view of a coupling having two radial passageways while FIG. 6 is an end view of a coupling having three radial passageways.

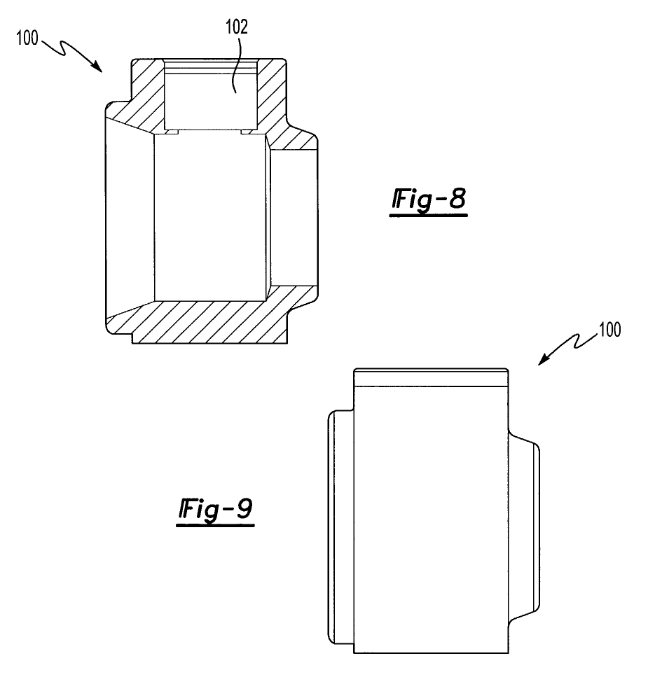

With reference to FIGS. 7-9, a still further preferred embodiment of a fluid coupling 100 having one radial passageway 102 (FIG. 8) is shown. The coupling 100 of FIGS. 7-9 differs from FIGS. 1-4 in that the exterior sides 104 taper from a main body portion 106 toward the outer open end of the passageway 102 as best shown in FIG. 7.

From the foregoing, it can be seen that the present invention provides a novel method for machining a fluid coupling from a section of bar stock without the previously known complex machining and material wastage known to the prior art methods. Having described my invention, however, many modifications thereto will become apparent to those skilled in the art to which it pertains without deviation from the spirit of the invention as defined by the scope of the appended claims.

I claim:

1. A method for manufacturing a fluid coupling comprising the steps of:
forming an elongated bar stock having a profile with a longitudinally extending protuberance projecting radially outwardly from a longitudinal axis of the bar stock,
machining a longitudinal end section of the bar stock, said end section having a portion of said protuberance,
machining a first fluid passageway longitudinally in said end section, and
machining a second fluid passageway in said portion of said end section,
wherein an axis of said first fluid passageway intersects an axis of said second fluid passageway at an angle.

2. The invention as defined in claim 1 wherein said forming step further comprises the step of drawing the bar stock through forming dies.

3. The invention as defined in claim 1 wherein said first passageway extends the entire length of said section.

4. The invention as defined in claim 3 wherein said first passageway has a diameter which varies along its length.

5. The invention as defined in claim 1 wherein the fluid coupling comprises a banjo coupling.

6. The invention as defined in claim 1 wherein the portion to be machined is first removed from said profile bar and subsequently machined as a separate workpiece.

7. The invention as defined in claim 1 and comprising the step of machining an outer periphery of the section.

8. The invention as defined in claim 1 and comprising the step of machining an outer periphery of the section prior to machining said fluid passageways.

9. The invention as defined in claim 1 and comprising the further step of removing the end section from the bar stock following said machining operations.
